(19) United States
(12) Patent Application Publication
(10) Pub. No.: US 2009/0103056 A1
(43) Pub. Date: Apr. 23, 2009

(54) PROJECTOR WITH A LENS COVER

(75) Inventors: MING-CHIH SUN, Tu-Cheng (TW); SHENG-HUNG CHEN, Tu-Cheng (TW); KAI HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/100,291

(22) Filed: Apr. 9, 2008

(30) Foreign Application Priority Data
Oct. 22, 2007 (CN) 200710202199.6

(51) Int. Cl. G03B 21/14

(52) U.S. Cl. 353/62

(57) ABSTRACT

A projector includes a light source, a light modulator for modulating light emitted from the light source, a lens module projecting the modulated light to form an image on a surface, and a lens cover. The lens cover includes a base portion positioned to the lens module, and a pattern defined in the base portion. When the projector is in operation and the lens cover is mounted on the lens module, an image is projected on the surface corresponding to the pattern.

### BACKGROUND

1. Technical Field

The present invention relates to a projector with a lens cover which can give a warning message to users.

2. Description of Related Art

A projector is generally equipped with a plastic lens cover for protecting the lens in the projector from being contaminated by dust or particles etc. when the projector is not in use. Sometimes, the lens cover is used for temporarily blocking the light from the projector when the projector is still in operation. Sometimes the projector is left that way when an operator forgets he has left the projector on with the lens cover in place. This puts the plastic lens cover at risk of being overheated and damaged by light from the projector.

What is needed, therefore, is a projector with a lens cover which can remind users the projector is in operation even when the lens cover is in place.

### SUMMARY

In accordance with a present embodiment, a projector includes a light source, a light modulator for modulating light emitted from the light source, a lens module for projecting the modulated light to form an image on a surface, and a lens cover. The lens cover includes a base portion positioned to the lens module, and a pattern defined in the base portion. When the projector is in operation and the lens cover is mounted on the lens module, an image is projected on the surface corresponding to the pattern.

Other advantages and novel features will be drawn from the following detailed description of at least one preferred embodiment, when considered in conjunction with the attached drawings.

### BRIEF DESCRIPTION OF THE DRAWINGS

Many aspects of the present projector can be better understood with reference to the following drawings. The components in the drawings are not necessarily drawn to scale, the emphasis instead being placed upon clearly illustrating the principles of the present projector. Moreover, in the drawings, like reference numerals designate corresponding parts throughout the several views.

FIG. 1 is a schematic view of a projector, according to a present embodiment.

FIG. 2 is an isometric view of a lens cover of the projector of FIG. 1.

FIG. 3 is a cross-sectional view of FIG. 2, taken along III-III line.

FIG. 4 is a cross-sectional view of an alternative lens cover.

FIG. 5 is a cross-sectional view of a further alternative lens cover.

### DETAILED DESCRIPTION OF THE EMBODIMENTS

Embodiments of the present projector will now be described in detail below and with reference to the drawings.

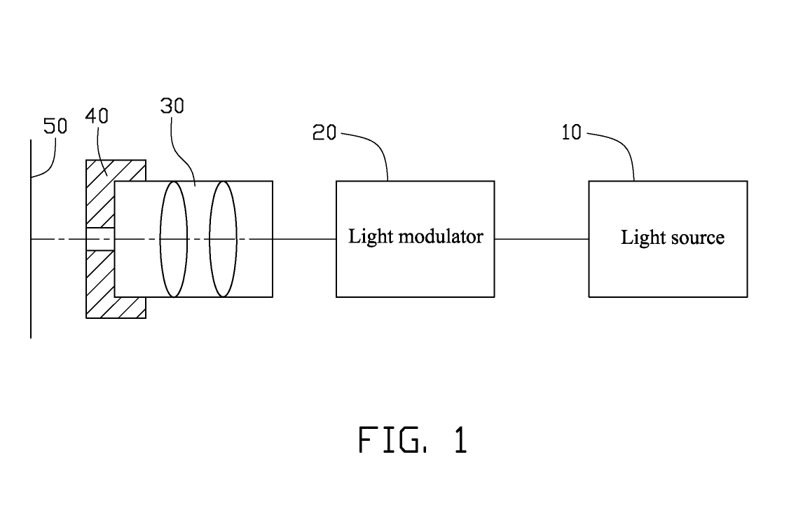

Referring to FIG. 1, a projector according to an embodiment comprises a light source 10, a light modulator 20, a lens module 30, and a lens cover 40 mounted on the lens module 30 at an imaging side of the lens module 30. The light modulator 20 modulates light emitted from the light source 10. The lens module 30 projects the modulated light to form an image on a surface 50. The lens cover 40 can temporarily block the modulated light when the projector is still in operation.

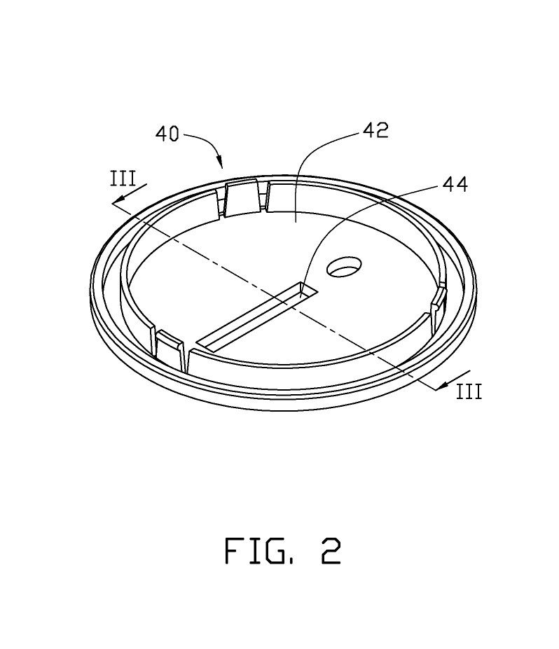

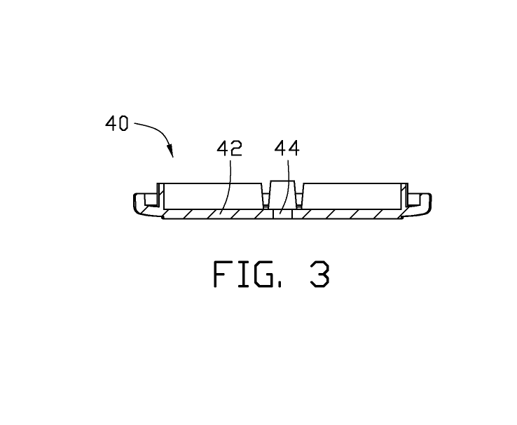

Referring to FIGS. 2-3, the lens cover 40 comprises a base portion 42 positioned to the lens module 30 and covering the lens module 30, and a pattern 44 extending through the base portion 42 comprising through holes in a desired shape, size, and pattern. In the embodiment, the pattern 44 is an exclamation symbol “!”. When the projector is in operation and the lens cover 40 is mounted to the lens module 30, an image is projected on the surface 50 corresponding to the pattern 44. This image on the surface 50 is taken as a warning message by the users that the projector is still in operation.

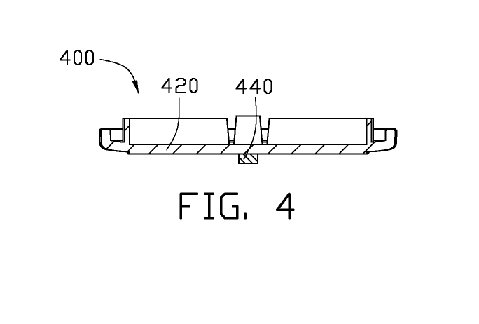

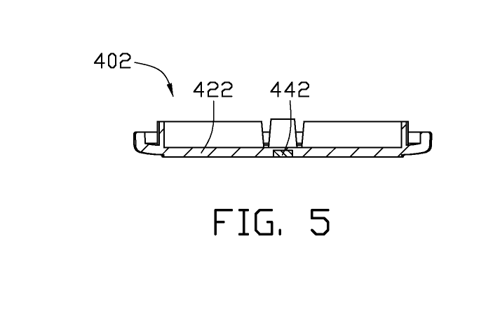

In another embodiment as shown in FIG. 4, a lens cover 400 with a pattern 440 is shown. The pattern 440 comprises translucent portions protruding from the base portion 420 and has transmittance thereof 50 percent higher than that of the base portion 420. For example, the transmittance of the base portion 420 is 20 percent, while the transmittance of the translucent pattern 440 is 80 percent, which is 60 percent higher than that of the base portion 420. FIG. 5 shows a further alternative lens cover 402, in which, a solid translucent pattern 442 is inlaid in the base portion 422.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A projector comprising:
a light source;
a light modulator for modulating light emitted from the light source;
a lens module for projecting the modulated light to form an image on a surface; and
a lens cover comprising a base portion positioned to the lens module, and a pattern defined in the base portion, wherein when the projector is in operation and the lens cover is mounted on the lens module, an image is projected on the surface corresponding to the pattern.

2. The projector as claimed in claim 1, wherein the pattern comprises through holes defined through the base portion.

3. The projector as claimed in claim 1, wherein the pattern comprises translucent portions formed in the base portion.

4. The projector as claimed in claim 3, wherein the translucent portions protrude from the base portion.

5. The projector as claimed in claim 3, wherein the translucent portions of the base portion are inlaid.

6. The projector as claimed in claim 3, wherein transmittance of the translucent portions is 50 percent higher than that of the base portion.
